(19) United States
(12) Patent Application Publication
(10) Pub. No.: US 2016/0336775 A1
(43) Pub. Date: Nov. 17, 2016

(54) USB Flash Memory Unit with Charging Arrangement

(71) Applicant: Sudong Cho, Arlington Heights, IL (US)

(72) Inventor: Sudong Cho, Arlington Heights, IL (US)

(21) Appl. No.: 14/714,274

(22) Filed: May 16, 2015

(51) Int. Cl. H02J 7/00; H01R 13/717; H01R 13/70; H01R 13/66

(52) U.S. Cl. CPC H02J 7/0042; H01R 13/665; H01R 13/7175; H01R 13/70

(57) ABSTRACT

A USB flash memory unit includes a main casing, a flash memory received in the main casing for storing a predetermined amount of data, a control module electrically connected to the flash memory, a USB connecting plug extended from the main casing for connecting to the external USB port, and a charging arrangement. The charging arrangement includes a charging module received in the main casing and electrically connected to the USB connecting plug, and a charging member extended from the main casing to electrically connect to the electronic device, the charging module being configured to acquire electricity from the external USB port of the power source device and output a predetermined current to the electronic device through the charging member for charging the electronic device.

### BACKGROUND OF THE PRESENT INVENTION

1. Field of Invention

The present invention relates to a flash memory, and more particularly to a USB flash memory which comprises a charging arrangement for charging electronic devices.

2. Description of Related Arts

A conventional flash memory, such as a USB flash memory, usually comprises a casing, a USB connecting plug extended from the casing, and a memory module received in the casing. The USB connecting plug is arranged to be inserted into a USB port of an electronic device such as a computer for facilitating transfer of data between the memory module and the electronic device.

The above-mentioned conventional flash memory suffers from an inadequacy that it does not provide any charging function for other electronic devices. Although aesthetic appearances of conventional flash memories has been substantially improved over the years, their functional features have not been substantially improved or broadened.

As a result, there is a need for a reliable and convenient USB flash memory which is capable of providing charging function to other electronic devices.

### SUMMARY OF THE PRESENT INVENTION

Certain variations of the present invention provide a USB flash memory unit which comprises a charging arrangement for rapidly charging electronic devices from an external USB port.

Certain variations of the present invention provide a USB flash memory unit which is capable of facilitating data transfer between the USB flash memory and a power source device on which the external USB port is provided.

Certain variations of the present invention provide a USB flash memory unit which is capable of simultaneously charging the electronic device and facilitating data transfer between the power source device and the USB flash memory.

In one aspect of the present invention, it provides a USB flash memory unit for connecting to an external USB port of a power source device and an electronic device, comprising:

a main casing;

a flash memory received in the main casing for storing a predetermined amount of data;

a control module electrically connected to the flash memory;

a USB connecting plug extended from the main casing for connecting to the external USB port; and

a charging arrangement, which comprises:

a charging module received in the main casing and electrically connected to the USB connecting plug; and

a charging member extended from the main casing to electrically connect to the electronic device, the charging module being configured to acquire electricity from the external USB port of the power source device and output a predetermined current to the electronic device through the charging member for charging the electronic device.

This summary presented above is provided merely to introduce certain concepts and not to identify any key or essential features of the claimed subject matter.

### BRIEF DESCRIPTION OF THE DRAWINGS

FIG. 1 is a perspective view of a USB flash memory according to a preferred embodiment of the present invention.

FIG. 2 is a schematic diagram of the USB flash memory according to the preferred embodiment of the present invention.

FIG. 3 is a block diagram of the USB flash memory according to the preferred embodiment of the present invention, illustrating the working principles of the USB flash memory.

FIG. 4 is a schematic diagram of the operation of the USB flash memory according to the preferred embodiment of the present invention.

FIG. 5 is a schematic diagram of a locking arrangement operation of the USB flash memory according to the preferred embodiment of the present invention.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

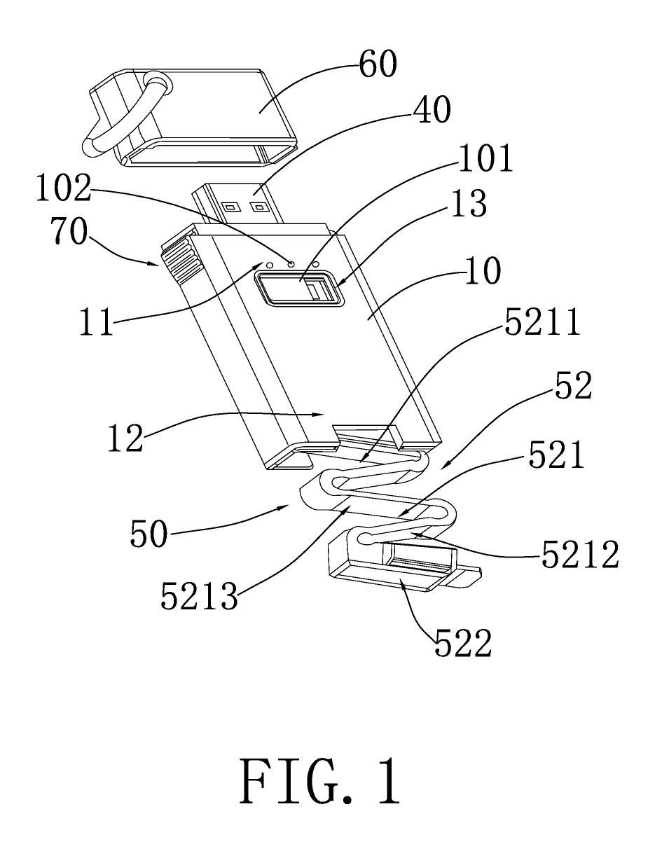

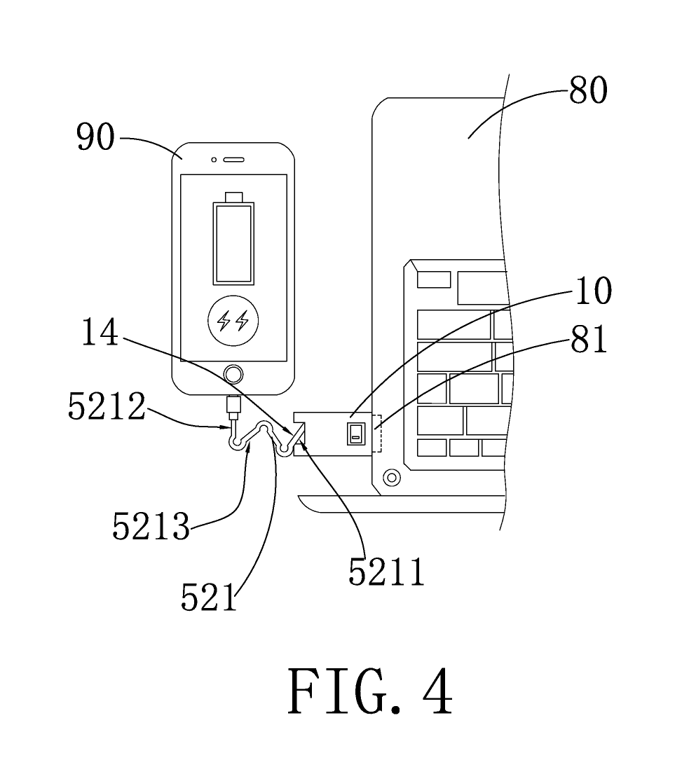

Referring to FIG. 1 to FIG. 5 of the drawings, a USB flash memory unit for connecting to an external USB port 81 of a power source device 80 and an electronic device 90 according to a preferred embodiment of the present invention is illustrated. Broadly, the USB flash memory unit may comprise a main casing 10, a flash memory 20 received in the main casing 10 for storing a predetermined amount of data, a control module 30 also received in the main casing 10 and electrically connected to the flash memory 20, a USB connecting plug 40, and a charging arrangement 50. Throughout this specification, the term “USB” carries a conventional meaning of Universal Serial Bus as a communication protocol. The power source device 80 may be an electronic device which provides a predetermined voltage output (such as a standard USB voltage output) utilized for charging the electronic device 90. An example of the power source device 80 is a computer. An example of the electronic device 90 is a smartphone.

The USB connecting plug 40 may be extended from the main casing 10 for connecting to the external USB port 81 of the power source device 80.

The charging arrangement 50 may comprise a charging module 51 and a charging member 52. The charging module 51 is received in the main casing 10 and electrically connected to the USB connecting plug 40 and the control module 30.

The charging member 52 is extended from the main casing 10 to electrically connect to the electronic device 90. The charging module 51 is configured to acquire electricity from the external USB port 81 of the power source device 80 and output a predetermined voltage to the electronic device 90 through the charging member 52 for charging the electronic device 90.

According to the preferred embodiment of the present invention, the main casing 10 may have a receiving cavity formed therein for accommodating the flash memory 20 and the charging arrangement 50. As shown in FIG. 1 of the drawings, the main casing 10 may have an elongated shape having a front end portion 11 and a rear end portion 12. The USB connecting plug 40 may be extended from the front end portion 11 of the main casing 10, while the charging member 52 of the charging arrangement 50 may be extended from the rear end portion 12 of the main casing 10.

The USB flash memory unit may further comprise a protective cap 60 detachably attached on the front end portion 11 of the main casing 10, and a locking arrangement 70 provided on the main casing 10. The protective cap 60 is for selectively protecting the USB connecting plug 40, while the locking arrangement 70 is arranged to selectively lock the protective cap 60 on the main casing 10.

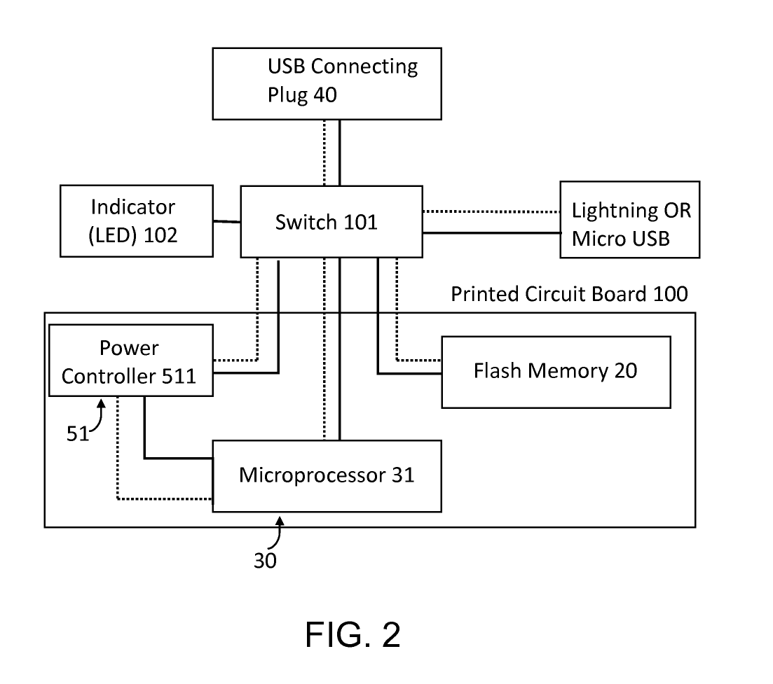

As shown in FIG. 2 of the drawings, the USB flash memory unit may further comprise a Printed Circuit Board 100 (PCB) which is arranged to implement the flash memory 20 for storing a predetermined amount of computer readable data therein, the control module 30, and the charging module 51. The control module 30 may comprise a microprocessor 31 electrically connected to or communicated with the flash memory 20. The microprocessor 31 is configured to control and facilitate date transfer between the flash memory 20 and the power source device 80.

The charging module 51 of the charging arrangement 50 may comprise a power controller 511 electrically connected to or communicated with the microprocessor 31 for providing a predetermined charging output voltage to the electronic device 90 through the charging member 52. In this preferred embodiment, the power controller 511 may be configured as an Integrated Circuit for controlling the output voltage delivered to the electronic device 90. This output voltage affects the modes of operation of the USB flash memory unit of the present invention as described below.

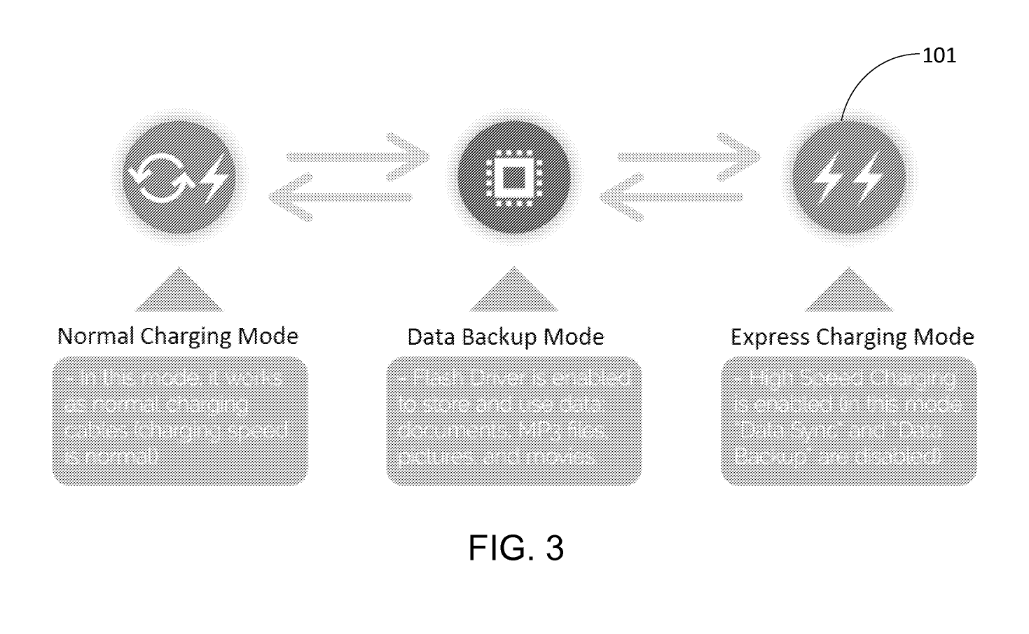

The USB flash memory unit may further comprise a switch 101 movably provided on the main casing 10 and is connected to the control module 30, the flash memory 20, the charging arrangement 40, and the USB connecting plug 40 through the PCB 100 for allowing a user of the present invention to switch the USB flash memory unit to operate between a normal charging mode, a data backup mode, and an express charging mode (see below for details). Accordingly, the main casing 10 may have an elongated slot 13. The switch 101 may be slidably mounted in the elongated slot 13 for switching between the normal charging mode, the data backup mode, and the express charging mode. Thus, the switch 101 may be selectively moved along the elongated slot 13 between three positions which correspond to switching the USB flash memory unit to operate between the three operation modes respectively (as shown in FIG. 3 of the drawings).

The USB flash memory unit may further comprise an indicator 102 provided on the main casing 10 for signaling an operation status of the USB flash memory unit. The indicator 102 may be exemplarily configured as a LED or other illuminating device.

In the normal charging mode, the switch 101 is moved to a predetermined position on the main casing 10 such that the microprocessor 31 is configured to control exchange of data between the flash memory 20 and the power source device 80, and at the same time allow charging of the electronic device 90 through a predetermined voltage output through the charging member 52. The output voltage is controlled by the power controller 511 which is coordinated by the microprocessor 31.

In the data backup mode, the switch 101 is moved to a predetermined positon on the main casing 10 such that the microprocessor 31 is configured to control exchange of data between the flash memory 20 and the power source device 80, and at the same time, no voltage is outputted to the charging member 52. In other words, the USB flash memory unit in this mode of operation will only enable exchange of data. The charging function is disabled.

In the express charging mode, the switch 101 is moved to a predetermined positon on the main casing 10 such that the microprocessor 31 is configured to allow voltage output through the charging member 52. The date exchange between the flash memory 20 and the power source device 80 is disabled. The output voltage for charging the electronic device 90 is controlled by the power controller 511. It is important to mention that in this particular mode of operation, the power controller 511 may output a relatively larger charging voltage which facilitates express charging of the electronic device 90. In the normal charging mode, the acquired power is shared between the flash memory 20 and the power controller 511. As a result, the output voltage through the charging member 52 is less than that of the express charging mode. In this preferred embodiment, the charging time for charging the electronic device 90 when the USB flash memory unit is in the express charging mode may be half of the charging time when the USB flash memory unit is in the normal charging mode.

From the above descriptions, it is clear that a user of the present invention may select, by operating on the switch 101, one of the three modes of operation as described above for performing data transfer between the power source device 80 and the USB flash memory unit, or for charging the electronic device 90.

The charging member 52 of the charging arrangement 50 may comprise a charging cable 521 having a first end 5211 connected to the rear end portion 12 of the main casing 10 and a second end 5212 movably extended to connect to the electronic device 90. The charging member 52 may further comprise a charging plug 522 formed at the second end 5212 of the charging cable 521 for connecting to the electronic device 90. The charging plug 522 may be configured as a micro USB plug which is adapted for connecting to a micro USB port of the electronic device 90.

The charging cable 521 may be configured as having a predetermined flexibility so that it can be collapsed to receive in the main casing 10 when it is not in use. Specifically, the main casing 10 may further has a receiving compartment 14 formed at the rear end portion 12 in such a manner that the charging cable 521 may be collapsed and folded to be accommodate in the receiving compartment 14 when it is not in use.

The charging cable 521 may be configured to be foldable so that the charging cable 521 may be divided into a plurality of cable sections 5213 in which each cable section 5213 may be folded toward an adjacent cable section 5213. Thus, the charging cable 521 may be folded to be received in the receiving compartment 14, or extended to connect to the electronic device 90.

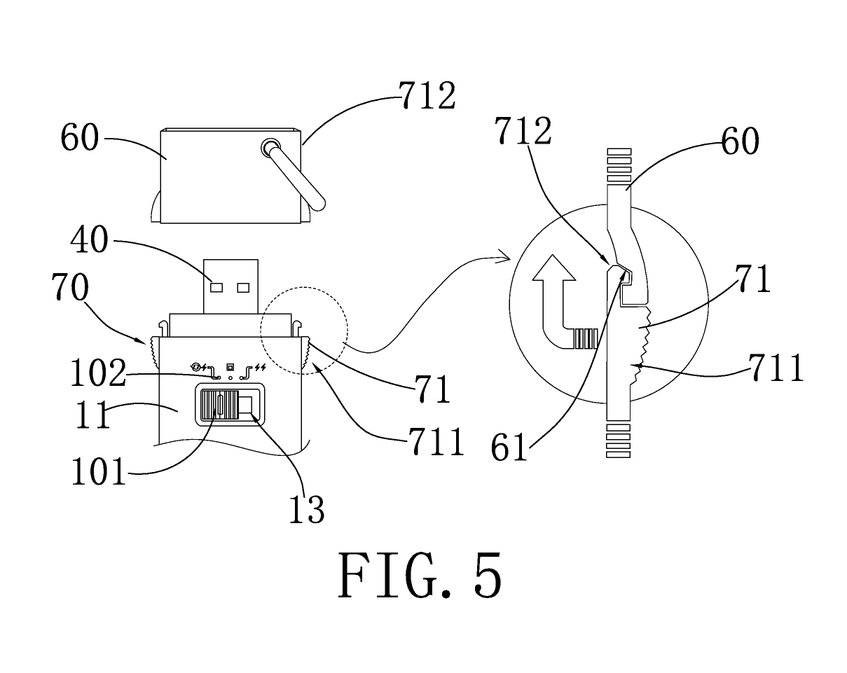

As shown in FIG. 5 of the drawings, the locking arrangement 70 may comprise a plurality of locking latches 71 movably provided from two sides of the main casing 10 respectively for detachably engaging with the protective cap 60. Each of the locking latches 71 has a depression portion 711 provided on the main casing 10 and an engaging portion 712 extended from the depression portion to normally engage with the protective cap 60 when the protective cap 60 covers the front end portion 11 of the main casing 10 and the USB connecting plug 40. The depression portions 711 of the locking latches 71 may be exposed on the main casing and may be slightly depressed by a user. When the depression portions 711 are slightly depressed, the engaging portions 712 are driven to disengage with the protective cap 60 for allowing the protective cap 60 from detaching from the main casing 10.

Moreover, the protective cap 60 may be configured as a hollow structure for covering the front end portion 11 of the main casing 10 and the USB connecting plug 40. In order to engage with the locking arrangement 70, the protective cap 60 may have a plurality of locking grooves 61 provided on two inner sides of the protective cap 60 for normally engaging with the locking latches 71 of the locking arrangement 70.

The present invention, while illustrated and described in terms of a preferred embodiment and several alternatives, is not limited to the particular description contained in this specification. Additional alternative or equivalent components could also be used to practice the present invention.

What is claimed is:

1. A USB flash memory unit for connecting to an external USB port of a power source device and an electronic device, comprising:
a main casing;
a flash memory received in said main casing for storing a predetermined amount of data;
a control module electrically connected to said flash memory;
a USB connecting plug extended from said main casing for connecting to said external USB port; and
a charging arrangement, which comprises:
a charging module received in said main casing and electrically connected to said USB connecting plug; and
a charging member extended from said main casing to electrically connect to said electronic device, said charging module being configured to acquire electricity from said external USB port of said power source device and output a predetermined output voltage to said electronic device through said charging member for charging said electronic device.

2. The USB flash memory unit, as recited in claim 1, wherein said control module comprises a microprocessor electrically connected to said flash memory, said microprocessor being configured to control and facilitate date transfer between said flash memory and said power source device.

3. The USB flash memory unit, as recited in claim 2, wherein said charging module of said charging arrangement comprises a power controller electrically connected to said microprocessor for providing a predetermined charging output voltage to said electronic device through said charging member.

4. The USB flash memory unit, as recited in claim 1, wherein said charging member of said charging arrangement comprise a charging cable having a first end connected to said main casing and a second end movably extended to connect to said electronic device, and a charging plug formed at said second end of said charging cable.

5. The USB flash memory unit, as recited in claim 4, wherein said charging cable is configured to be foldable.

6. The USB flash memory unit, as recited in claim 5, wherein said main casing has a receiving compartment, said charging cable being arranged to be normally folded and received in said receiving compartment.

7. The USB flash memory unit, as recited in claim 2, further comprising a switch movably provided on said main casing and is connected to said control module, said flash memory, said charging arrangement, and said USB connecting plug, said switch being arranged to be switched to operate said USB flash memory unit between a normal charging mode, a data backup mode, and an express charging mode,
wherein in said normal charging mode, said switch is actuated such that said microprocessor is configured to control exchange of data between said flash memory and said power source device, and at the same time allow charging of said electronic device through a predetermined voltage output through said charging member,
wherein in said data backup mode, said switch is actuated such that said microprocessor is configured to control exchange of data between said flash memory and said power source device, and
wherein in said express charging mode, said switch is actuated such that said microprocessor is configured to allow voltage output through said charging member without allowing exchange of data between said flash memory and said power source device.

8. The USB flash memory unit, as recited in claim 5, further comprising a protective cap detachably attached on said main casing to accommodate said USB connecting plug, and a locking arrangement provided on said main casing for detachably locking said protective cap on said main casing.

9. The USB flash memory unit, as recited in claim 7, further comprising a protective cap detachably attached on said front end portion of said main casing to accommodate said USB connecting plug, and a locking arrangement provided on said main casing for detachably locking said protective cap on said main casing.

10. The USB flash memory unit, as recited in claim 8, wherein said locking arrangement comprises a plurality of locking latches movably provided from two sides of said main casing respectively for detachably engaging with said protective cap.

11. The USB flash memory unit, as recited in claim 9, wherein said locking arrangement comprises a plurality of locking latches movably provided from two sides of said main casing respectively for detachably engaging with said protective cap.

12. The USB flash memory unit, as recited in claim 10, wherein each of said locking latches has a depression portion provided on said main casing and an engaging portion extended from said depression portion to normally engage with said protective cap when said protective cap covers said main casing and said USB connecting plug.

13. The USB flash memory unit, as recited in claim 11, wherein each of said locking latches has a depression portion provided on said main casing and an engaging portion extended from said depression portion to normally engage with said protective cap when said protective cap covers said main casing and said USB connecting plug.

14. The USB flash memory unit, as recited in claim 12, wherein said protective cap is configured as a hollow structure and has a plurality of locking grooves for normally engaging with said locking arrangement.

15. The USB flash memory unit, as recited in claim 13, wherein said protective cap is configured as a hollow structure and has a plurality of locking grooves for normally engaging with said locking arrangement.

16. The USB flash memory unit, as recited in claim 2, wherein said main casing is configured to have an elongated shape and has a front end portion and a rear end portion, said USB connecting plug being extended from said front end portion, while said charging member of said charging arrangement being extended from said rear end portion.

17. The USB flash memory unit, as recited in claim 7, wherein said main casing is configured to have an elongated shape and has a front end portion and a rear end portion, said USB connecting plug being extended from said front end portion, while said charging member of said charging arrangement being extended from said rear end portion.

18. The USB flash memory unit, as recited in claim 15, wherein said main casing is configured to have an elongated shape and has a front end portion and a rear end portion, said USB connecting plug being extended from said front end portion, while said charging member of said charging arrangement being extended from said rear end portion.

19. The USB flash memory unit, as recited in claim 2, further comprising an indicator provided on said main casing.

20. The USB flash memory unit, as recited in claim 7, further comprising an indicator provided on said main casing.
